(19) United States
(12) Patent Application Publication
(10) Pub. No.: US 2007/0026335 A1
(43) Pub. Date: Feb. 1, 2007

(54) Toner, image forming method and process cartridge

(76) Inventors: Atsushi Yamamoto, Kawanishi-shi (JP); Yoshihiro Mikuriya, Nishinomiya-shi (JP); Katsunori Kurose, Takarazuka-shi (JP); Masayuki Hagi, Minoo-shi (JP); Takuya Kadota, Kobe-shi (JP); Hiroaki Katoh, Nagaokakyo-shi (JP); Masahide Inoue, Katsuragi-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/496,512

(22) Filed: Aug. 1, 2006

(30) Foreign Application Priority Data
Aug. 1, 2005 (JP) 2005-223154

(51) Int. Cl. G03G 9/08

(52) U.S. Cl. 430/108.8; 430/108.1; 430/109.4; 430/125

(57) ABSTRACT

A toner containing a binder resin containing a resin having a polyester skeleton, a wax containing a hydrocarbon based wax, a colorant, and a charge controlling agent represented by the following chemical structure, wherein the toner has at least one endothermic peak in a range of from 60 to 80 ° C. when measured by a differential scanning calorimetry (DSC). 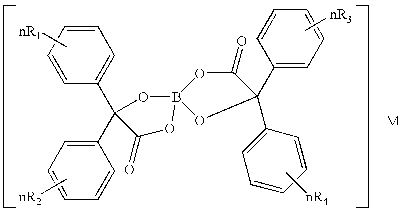
In the chemical structure, M represents one of Li, Na and K, R₁, R₂, R₃ and R₄ each, independently, represent one of a hydrogen atom, an alkyl group having 1 to 4 carbon atoms, an alkoxy group having 1 to 4 carbon atoms, and a halogen atom, and n represents an integer of from 1 to 5, and when n is from 2 to 5, each of R₁, R₂, R₃ and R₄ can be different from the other.

### BACKGROUND OF THE INVENTION

1. Field of the Invention

The present invention relates to a toner, and its corresponding image forming method and process cartridge.

2. Discussion of the Background

In an image forming apparatus operating as electrophotographic system, toner images are formed through a charging process, an irradiating process, and a developing process. The charging process is a process of discharging the surface of a photoreceptor, i.e., an image bearing member or infusing charges thereto. The irradiating process is a process of irradiating the surface of the charged photoreceptor to form a latent electrostatic image thereon. The developing process is a process of developing the latent electrostatic image with a toner having a polarity reversed relative to the polarity of the latent electrostatic image formed on the surface of the photoreceptor. Subsequently, the toner image is transferred via a transfer process in which the toner image formed on the photoreceptor is temporarily transferred to an intermediate transfer body and transferred therefrom to a recording medium such as paper or is directly transferred from the photoreceptor thereto. Thereafter, the toner image is fixed on the recording medium upon application of heat and pressure thereto in a fixing process. Toner remaining on the photoreceptor and the intermediate transfer body are removed to be ready for the next cycle of image formation.

With the advance of electrophotography, machines such as laser printers, photocopiers and multi-function peripherals (hereinafter referred to as MFP) based on electrophotography are used more and more in offices, etc.

Further, compact-sized printers, photocopiers and MFPs which can stably output quality images under a wide variety of circumstances have been demanded from the market.

In addition, color printers and color MFPS which can output appealing documents, are now about to be the main stream.

Single-Component Development

There are two development systems in the current electrophotographic process. One is a two-component developing system using a carrier and the other is a single-component system dispensing with a carrier. In a two-component developing system, it is necessary to uniformly mix the toner and the carrier. Apparatus for performing this mixing is inevitably bulky, and therefore, the single component developing system is preferred in terms of reduction in size of an electrophotographic machine.

However, it is desired to provide a toner regulating member to form a layer having a uniform thickness of a toner on the surface of a toner transfer member. It is relatively difficult to control forming such a uniform layer in comparison with the case of the two-component developing system. One of the reasons therefor is that a toner does not have a uniform or desired chargeability.

To address this defect, a development system using a magnetic toner is known in which a uniform thin layer of a magnetic toner is formed while the magnetic toner is stirred by a magnetic sleeve and subsequently the magnetic toner is supplied to the developing portion for development. However, such a system using a magnetic sleeve uses a heavy permanent magnet. In addition, the magnetic sleeve magnetically attaches and detaches the magnetic toner via an endless belt suspended over with other rollers. This prevents the magnetic sleeve from directly contacting the magnetic toner. Thereby, the surface of the magnetic sleeve is prevented from being contaminated. As a result, a developing unit including such a system is inevitably large in size and complicated in structure. In consideration of this, the system using a magnetic toner is not suitable to fully utilize merits of a single-component developing system. Further, the magnetic body used in a magnetic toner has a color. Therefore, it is difficult to apply such a magnetic toner to a color printer. A non-magnetic single-component developing system, in which the layer thickness of the toner is regulated by a toner layer regulating member instead of a magnetic sleeve, can be relatively small-sized in comparison with the case of a single-component developing system using a magnetic toner. As a system using a non-magnetic and single-component toner, a developing device is known in which a toner transfer member, a toner supplying member for supplying a toner to the surface of the toner transfer member, and a toner layer regulating member contacting the surface of the toner transfer member are provided. The toner layer regulating member regulates the layer thickness of the toner supplied to the surface of the transfer member.

However, for a developing system using such a developing device taking a non-magnetic and single-component developing system, which is “a developing device having a toner transfer member, a toner supplying member for supplying a toner to the surface of the toner transfer member, and a toner layer regulating member contacting the surface of the toner transfer member and regulating the layer thickness of the toner supplied to the surface of the transfer member”, it is not easy to improve the device in terms of quality images. Therefore, it is a single component developer, i.e., a toner, that has to be improved. According to the study made by the inventors of the present invention, typical toners are not suitable for use in a single-component developer developing device. For example, a toner using a polyester resin as a binder resin has a great diversity and latitude in terms of designing physicality. Therefore, such a toner has a good fluidity, i.e., a relatively small agglomeration property and adhesiveness, at room temperature. Such a toner is also sharp-melting during fixing upon application of heat. Therefore, polyester resins have been popularly used recently as a binder resin for a toner.

In addition, the demand for high speed photocopying and saving energy has grown more and more in recent years. To satisfy this demand, a toner is preferred to have an instant and easy melting and attaching property at a low temperature. Further, to satisfy the demand for high definition images, a toner having a small particle diameter which can be quickly charged and have a stable and uniform chargeability has been used. Therefore, a single component developer (i.e., toner) having a good and stable chargeability is desired

Published unexamined Japanese patent applications Nos. (hereinafter referred to as JOP) 2004-219507, H03-39973, 2003-43809, 2003-29533, H05-165257 and H03-221968 describe a technology in which a non-magnetic and single-component toner contains a complex of boron benzylic acid as a charge controlling agent.

In addition, JOPs 2004-24590, 2003-149859, 2001-66824, H10-254177, H09-288383, H09-288381, H09-288380 and H06-250442 and Japanese Patent No. 3412439 describe a technology in which a polyester is used as a binder resin and a complex of boron benzylic acid is used as a charge controlling agent.

It is possible to uniformly form a thin layer of a toner on a toner supplying member and obtain a sharp distribution of the amount of charge of the toner by containing a complex of boron benzylic acid in a non-magnetic and single-component toner in a suitable amount. However, the effect of a complex of boron benzylic acid extremely deteriorates on environmental change, especially, at a high temperature and high humidity environment.

Because of these reasons, a need exists for a toner by which quality images can be produced without image noise and causing contamination in an image forming apparatus having a toner layer regulating member at high temperature and high humidity and its corresponding image forming method and process cartridge.

### SUMMARY OF THE INVENTION

The present invention is to provide a toner by which quality images can be produced at high temperature and high humidity without image noise and without causing contamination in an image forming apparatus having a toner layer regulating member and its corresponding image forming method and process cartridge.

Briefly this object and other objects of the present invention as hereinafter described will become more readily apparent and can be attained, either individually or in combination thereof, by a toner containing a binder resin containing a resin having a polyester skeleton, a wax containing a hydrocarbon based wax, a colorant, and a charge controlling agent represented by the following chemical structure. In addition, the toner has at least one endothermic peak in a range of from 60 to 80° C. when measured by a differential scanning calorimetry (DSC): 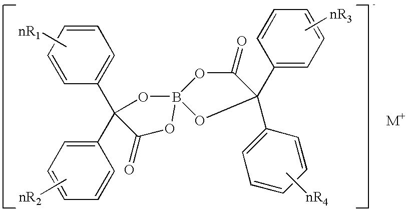
In the chemical structure, M represents one of Li, Na and K, R₁, R₂, R₃ and R₄ each, independently, represent one of a hydrogen atom, an alkyl group having 1 to 4 carbon atoms, an alkoxy group having 1 to 4 carbon atoms, and a halogen atom, and n represents an integer of from 1 to 5, and when n is from 2 to 5, each of R₁, R₂, R₃ and R₄ can be different from the other;

an image forming method using the toner, and a process cartridge containing the toner.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of the developing device and the process cartridge in which non-magnetic and single-component toner of the present invention is used; and

FIG. 2 is a graph illustrating the DSC curve of an example of the toners of the present invention.

### DETAILED DESCRIPTION OF THE INVENTION

As a result of the intensive study by the present inventors, the present invention was made. Below is a detailed description of the present invention including embodiments thereof.

The present invention relates to a toner containing a binder resin containing a resin having a polyester skeleton, a wax containing a hydrocarbon based wax, a colorant, and a charge controlling agent represented by the following chemical structure. In addition, the toner has at least one endothermic peak in a range of from 60 to 80° C. when measured by a differential scanning calorimetry (DSC):

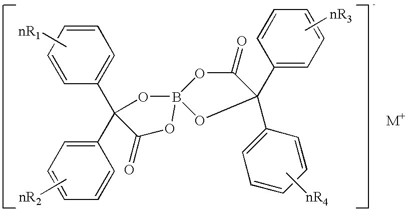

In the chemical structure, M represents one of Li, Na and K, R₁, R₂, R₃ and R₄ each, independently, represent one of a hydrogen atom, an alkyl group having 1 to 4 carbon atoms, an alkoxy group having 1 to 4 carbon atoms, and a halogen atom, and n represents an integer of from 1 to 5, and when n is from 2 to 5, each of R₁, R₂, R₃ and R₄ can be different from the other.

It is still further preferred that, in the toner mentioned above, the binder resin comprises a polyester based resin.

It is still further preferred that, in the toner mentioned above, the binder resin contains a hybrid resin having a styrene skeleton portion and a polyester skeleton portion.

It is still further preferred that, in the toner mentioned above, the half width value of the endothermic peak is not greater than 8° C.

It is still further preferred that, in the toner mentioned above, the ratio of the weight of a diol skeleton to the weight of a monool skeleton in the binder resin is from 99/1 to 75/25.

It is still further preferred that, in the toner mentioned above, the hydrocarbon based wax has an acid value of not greater than 0.5 mgKOH/g.

It is still further preferred that, in the toner mentioned above, the content of the hydrocarbon based wax is from 2 to 15 parts by weight based on 100 parts by weight of the binder resin.

It is still further preferred that, in the toner mentioned above, the content of the charge controlling agent is from 0.5 to 5 parts by weight based on 100 parts by weight of the binder resin.

As another aspect of the present invention, a developing device is provided which includes a toner transfer member, a toner supplying member for supplying the toner mentioned above to the surface of the toner transfer member, and a toner regulating member for regulating a layer thickness of the toner supplied to the surface of the toner transfer member while contacting the toner transfer member.

It is preferred that the toner supplying member of the developing device mentioned above is in the form of a roller.

As another aspect of the present invention, an image forming method is provided which includes charging an image bearing member, irradiating a surface of the image bearing member to form a latent electrostatic image thereon, supplying the toner mentioned above by a toner supplying device to a surface of a toner transferring member, regulating a thickness of a layer of the toner on the surface of the toner transferring member, developing the latent electrostatic image with the toner to form a visualized toner image, transferring the visualized toner image to a recording medium and cleaning the surface of the image bearing member.

It is preferred that, in the method mentioned above, the polyester resin contains a polyester based resin.

It is still further preferred that, in the method mentioned above, the binder resin contains a hybrid resin having a styrene skeleton portion and a polyester skeleton portion.

It is still further preferred that, in the method mentioned above, the half width value of the endothermic peak is not greater than 8° C.

It is still further preferred that, in the method mentioned above, the ratio of the weight of a diol skeleton to the weight of a monool skeleton in the binder resin is from 99/1 to 75/25.

It is still further preferred that, in the method mentioned above, the wax has an acid value of not greater than 0.5 mgKOH/g.

It is still further preferred that, in the method mentioned above, the content of the hydrocarbon based wax is from 2 to 15 parts by weight based on 100 parts by weight of the binder resin.

It is still further preferred that, in the method mentioned above, the content of the charge controlling agent is from 0.5 to 5 parts by weight based on 100 parts by weight of the binder resin.

As another aspect of the present invention, a process cartridge is provided which contains a toner transfer member, a toner supplying member for supplying the toner mentioned above to the surface of the toner transfer member, and a toner regulating member for regulating a layer thickness of the toner supplied to the surface of the toner transfer member while contacting the toner transfer member.

Developing Device for Non-Magnetic and Single-Component Developer

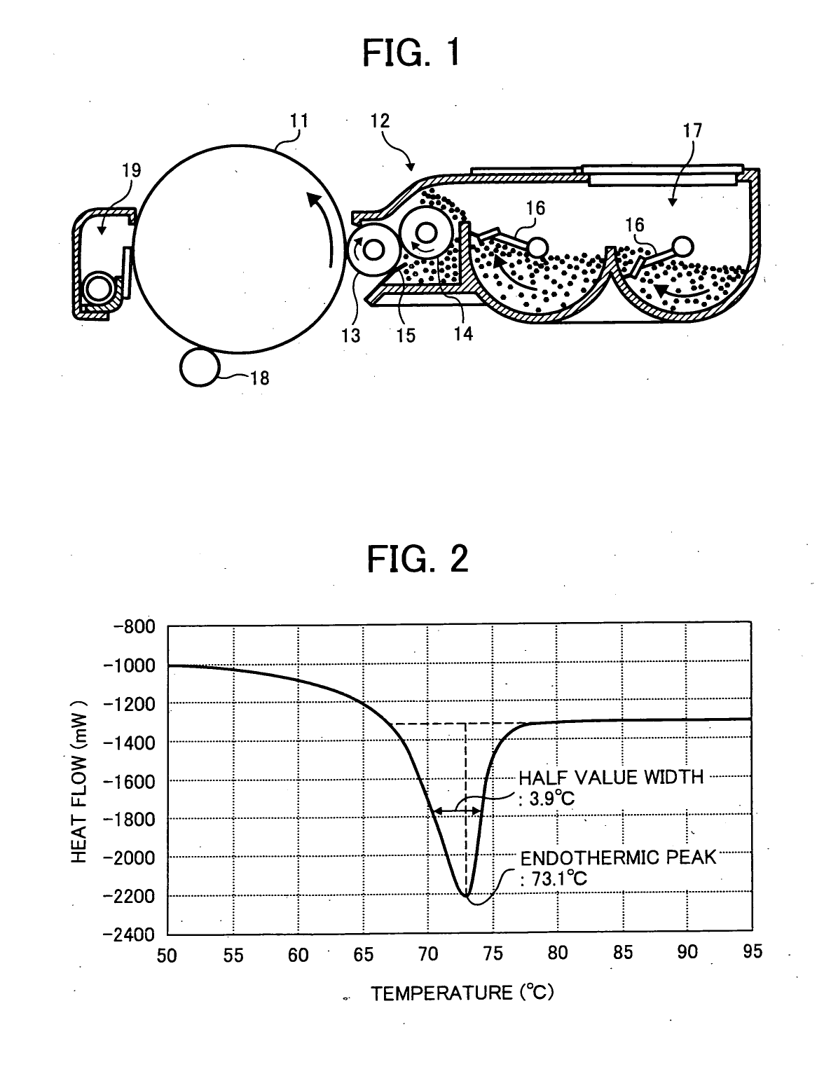

FIG. 1 is a diagram illustrating an example of the developing device of the present invention for a non-magnetic and single-component developer and the process cartridge therefore.

The process cartridge includes a developing roller 13 serving as a toner transfer member, a layer regulating member 15 serving as a toner layer regulating member, a supplying roller 14 serving as a toner supplying member for supplying the toner to the surface of the toner transfer member, and a stirring paddle 16. The process cartridge is fixed to a case 12 accommodating the toner. Further, the developing device for a non-magnetic and single-component developer includes the process cartridge, a latent electrostatic image bearing member 11, a charging device 18 and a cleaning device 19. The charging device 18 and the cleaning device 19 are disposed around the latent electrostatic image bearing member 11. 17 represents a toner accommodating portion. In FIG. 1, an imagewise irradiation device as an example of a latent electrostatic image forming device and a transfer device for transferring the toner to a toner image receiving body are not shown.

With regard to the developing roller 13, a roller covered with an elastic rubber layer is preferably used. Further, the developing roller has a surface coating layer made of a material easily charged with the polarity reversed to the polarity of the toner. The elastic layer is set to have a hardness of not greater than 60 degree on JIS-A to prevent deterioration of the toner caused by concentration of pressure at the contact portion of the developing roller 13 and the layer regulating member 15. The developing roller 13 is set to have a surface roughness Ra of from 0.3 to 2.0 μm to retain a sufficient amount of the toner on the surface thereof. In addition, since a developing bias is applied to form an electric field between the developing roller 13 and the latent electrostatic image bearing member 11, the elastic tube layer is set to have a resistance of from 10³ to 10¹⁰Ω. The developing roller 13 rotates clockwise in FIG. 1 and transfers the toner retained on the surface thereof to the positions opposing the layer regulating member 15 and the latent electrostatic image bearing member 11.

The layer regulating member 15 is disposed below relative to the contact portion of the supplying roller 14 and the developing roller 13. The layer regulating member 15 is made of a metal plate spring material such as SUS and phosphor bronze and the free end thereof contacts the surface of the developing roller 13 with a pressure of from 10 to 40 N/m. When the toner passes under this pressure, the layer regulating member 15 imparts charges to the toner by friction while forming a uniform thin layer of the toner. Further, to assist the friction charging, a regulating bias having the same polarity as that of the developing bias to offset the developing bias is applied to the layer regulating member 15.

There is no specific limit to the selection of the elastic rubber forming the surface of the developing roller 13. Specific examples thereof include, but are not limited to, styrene-butadiene based copolymer rubber, acrylonitrile-butadiene based copolymer rubber, acrylic rubber, epichlorohydrin rubber, urethane rubber, silicone rubber, and combinations thereof. Among these, a combination of epichlorohydrin rubber and acrylonitrile-butadiene based copolymer rubber is preferably used.

The developing roller for use in the present invention is manufactured by covering an electroconductive shaft with a rubber elastic body. The electroconductive shaft is composed of, for example, a metal such as stainless steel.

Non-Magnetic and Single Component Toner

As a result of the intensive study by the present inventors, it is found that a toner having a binder resin containing a resin having a polyester skeleton, a hydrocarbon based wax in a suitable amount and a compound represented by the following chemical structure (1) can significantly improve the developing characteristics in a severe environment, e.g., repetitive image forming under a high temperature and high humidity environment.

The mechanism of this has not been clearly illustrated but can be deduced as follows.

The compound represented by the chemical structure (1) is known as a compound for controlling the chargeability of a toner as already described in JOP H03-221968. However, especially in the process of using a non-magnetic and single-component toner containing a binder resin containing a resin having a polyester skeleton, this compound is found to also have a characteristic of imparting good developing characteristics to the toner such that the toner is uniformly placed on the surface of the image bearing member and the toner does not scatter from the developing device.

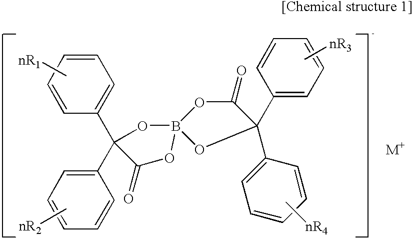

wherein M represents one of Li, Na and K, R₁, R₂, R₃ and R₄ each, independently, represent one of a hydrogen atom, an alkyl group having 1 to 4 carbon atoms, an alkoxy group having 1 to 4 carbon atoms, or a halogen atom, and n represents an integer of from 1 to 5, and when n is from 2 to 5, each of R₁, R₂, R₃ and R₄ can be different from the other.

However, since the compound represented by the chemical structure (1) is a salt in which an alkali metal is a counter cation, and the compound is water-soluble when the number of substitute groups therein is small, the compound is deduced to have a tendency of absorbing humidity in the air. In the process using a non-magnetic and single-component developer in a high temperature and high humidity environment, while a voltage is repetitively applied to the toner containing a resin having a polyester skeleton by a toner bearing member and a toner layer regulating member or a toner bearing member and a toner supplying member, the charge controlling agent represented by the chemical structure (1) which has absorbed humidity is subject to chemical reaction such as electrolytic process, resulting in deterioration of developing characteristics.

In the present invention, the content of the charge controlling agent mentioned above is preferred to be from 0.5 to 5 parts by weight based on the binder resin mentioned above. When the content of the charge controlling agent is too small, the charge may not be sufficiently controlled. An addition of an excessive amount of the charge controlling may not have an impact on improving the effect and may have an adverse impact on, for example, rapid melting at a low temperature.

Hydrocarbon based waxes have an extremely weak compatibility with a binder resin of a toner containing a resin having a polyester skeleton. Therefore, with regard to a toner obtained by mixing, melting and kneading, pulverizing and classifying a toner material containing the hydrocarbon based wax and the binder resin containing a resin having a polyester skeleton, part of the hydrocarbon based wax used is detached from the toner and attached to or present on the surface of the toner. However, hydrocarbon based waxes do not have a function group and therefore have an extremely weak moisture absorption property and are chemically stable. Therefore, the hydrocarbon based wax existing on the surface of a toner is inactive to chemical reaction upon application of voltage in a high temperature and high humidity environment and prevents the charge controlling agent represented by the chemical structure (1) from moisture absorption and chemical change. As a result, a toner containing a hydrocarbon wax in a suitable amount, the charge controlling agent (1) represented by the chemical structure (1) and a resin having a polyester skeleton is considered to be able to maintain good developing characteristics in a high temperature and high humidity environment.

The hydrocarbon based wax for use in the present invention is preferred to have an acid value of not greater than 0.5 mgKOH/g.

As described above, the process of using a non-magnetic and single-component developer is a developing process, in which a toner transfer member rotatable, a toner supplying member including a supplying roller for supplying a toner to the surface of the rotatable toner transfer member while contacting the rotatable toner transfer member, and a toner layer regulating member for regulating the layer thickness of the toner supplied to the surface of the toner transfer member while contacting the toner transfer member are used.

According to the reason described above, a hydrocarbon based wax is preferred as the wax for use in the present invention. For example, the developing characteristics of a toner that does not include such a wax significantly deteriorates in a high temperature and high humidity environment. As a result, streaks along the transfer direction of a toner and toner slipping outside the developing device are observed. When the transfer streak occurs, a white streak is observed in an output image, which is great damage to the quality thereof. In addition, the toner slipping outside the developing device contaminates the inside of an image forming apparatus. As a result, when a user exchanges a toner bottle, an image bearing member, a developing device, an intermediate transfer belt, and a process cartridge integrally including part or all of them, the slipped toner contaminates hands and/or clothes of the user. Further, the output images are also contaminated, resulting in extreme degradation of image quality. Therefore, this must be avoided.

In addition, when a wax such as an ester having a functional group is used, the phenomenon described above is relieved. But the transfer streak and toner slipping are observed when images are repeatedly formed over an extended period of time. In the present invention, R₁, R₂, R₃ and R₄ each, independently, represent a hydrogen atom, an alkyl group having 1 to 4 carbon atoms, an alkoxy group having 1 to 4 carbon atoms or a halogen atom. Specific examples of the alkyl groups include, but are not limited to, methyl group, ethyl group, n-propyl group, isopropyl group, n-butyl group, isobutyl group, sec-butyl group, and tert-butyl group. Specific examples of the alkoxy groups include, but are not limited to, methoxy group, ethoxy group, n-propyloxy group, isopropyloxy group, n-butyloxy group, sec-butyloxy group and tert-butyloxy group. Specific examples of the halogen atoms include, but are not limited to, a fluorine atom, a chlorine atom, and a bromine atom. Each of R₁, R₂, R₃ and R₄ can be present in a multiple number. In such a case, each of R₁, R₂, R₃ and R₄ can be different or the same. The character n represents an integer of from 1 to 5. M represents Li, Na or K. In consideration of the desired anti-moisture absorption, Na or K is preferred.

The compound represented by the chemical structure (1) can be easily prepared by adding the compound represented by the following chemical structure (2) (wherein, R₁, R₂, R₃ and R₄ are the same as those for the chemical structure (1)) to an aqueous medium of boric acid and NaOH, KOH or LiOH and stirring and reacting the mixture for about 2 hours at 80° C.

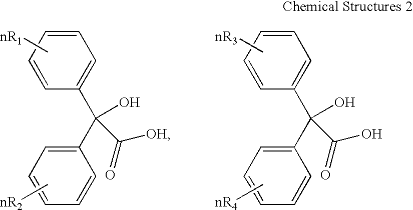

Below are specific examples of the charge controlling agents which can be used in the present invention.

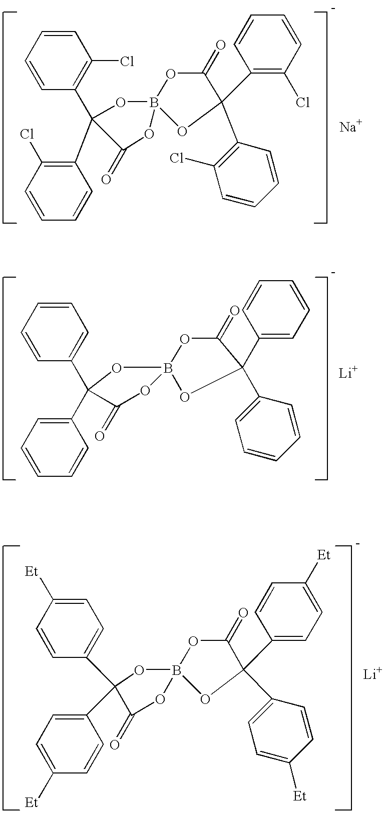

In the present invention, the content of the charge controlling agent mentioned above is preferred to be from 0.5 to 5 parts by weight based on the binder resin mentioned above. When the content of the charge controlling agent is too small, the charge may not be sufficiently controlled. An addition of an excessive amount of the charge controlling may not have an impact on improving the effect and may have an adverse impact on, for example, rapid melting at a low temperature.

Binder Resin

As the binder resin for use in the present invention, it is preferred to use a binder resin having a polyester skeleton, in which the weight ratio of the diol skeleton to the monool skeleton is from 99/1 to 72/55. The binder resin more preferably contains a polyester based resin and a hybrid resin having at least both a styrene skeleton portion and a polyester skeleton portion.

Diol Skeleton

The diol skeleton is part of the skeleton of a polyester unit. Polyester resins are suitably used as the binder resins in the present invention because of their moderate strength and hot melting property.

Specific examples of the diols include, but are not limited to, alkylene glycols (e.g., ethylene glycol, 1,2-propylene glycol, 1,3-propylene glycol, 1,4-butane diol, and 1,6-hexane diol); alkylene ether glycols (e.g., diethylene glycol, triethylene glycol, dipropylene glycol, polyethylene glycol, polypropylene glycol, and polytetra methylene ether glycol); alicyclic diols (e.g., 1,4-cyclohexane dimethanol, and hydrogen added bisphenol A); bisphenols (e.g., bisphenol A, bisphenol F and bisphenol S); and adducts of the bisphenols mentioned above with an alicyclic diol (ethylene oxide, propylene oxide and butylenes oxide).

Among these, alkylene glycols having 2 to 12 carbon atoms and adducts of bisphenol with an alkylene oxide, and a combination of an adduct of bisphenol with an alkylene oxide and an alkylene glycol having 2 to 12 carbon atoms are preferred.

Monool Skeleton

The monool skeleton is a unit having a high compatibility with the hydrocarbon based waxes for use in the present invention and is considered to control the amount of the hydrocarbon based wax existing on the surface of a toner in a suitable range. When the content of the monool skeleton is too small, most of the hydrocarbon based wax is exposed to the surface of a toner, which leads to the contamination of a toner bearing member and a toner layer regulating member. As a result, the toner is not sufficiently charged, which may cause the slipped toner, etc. When the content of the monool skeleton is too large, most of the hydrocarbon based wax is contained in the toner and may lose the effect of protecting the surface of the toner. The monool skeleton represents a monool residue and specific examples thereof include, but are not limited to, ether residues and phenol residues, which can be modified by a hydrocarbon group, for example, a substituted or non-substituted alkyloxy group, an alloalkyloxy group, an alkyl aryloxy group, and an aryloxy group.

Specific examples of the monols include, but are not limited to, ethanol, propanol, isopropanol, 1-butanol, 2-butanol, t-butanol, 1-hexanol, 1-octanol, 2-ethyl-1-hexanol, 1-decanol, 1 -dodecanol, 1-ocatadodecanol, behenyl alcohol, 4-nonyl phenyl, 3-phenyl propanol, 4-phenyl butanol and 5-phenyl pentanol.

Introducing Monool Skeleton

Monool skeletons are introduced and used as follows:
(1) Use a resin prepared by at least ester-linking the end of the acid of a polyester with a monool as a binder resin;
(2) Use a polymer having a monool skeleton in its branched chain and a polyester as a binder resin;
(3) Use a hybrid resin having a polymer unit having a monool skeleton in its branched chain and a polyester unit; and
(4) Use (1) to (3) in any combination.

Among them, (3) is preferred.

Polymer Unit Having Monool Skeleton in its Branched Chain

As the polymer unit having a monool skeleton in its branched chain, a polymer unit obtained by co-polymerizing a monomer containing an ester of an addition-polymerizable carboxylic acid and monool can be used.

As the addition-polymerizable carboxylic acids, acrylic acid, methacrylic acid, maleic acid, itaconic acid and p-vinyl benzoic acid can be preferably used.

To obtain the polymer unit having a monool skeleton in its branched chain, it is possible to singly polymerize an addition-polymerizable carboxylic ester, which is an ester of these carboxylic acids and a monool. The polymer unit having a monool in its branched chain can also be obtained by co-polymerizing an addition-polymerizable carboxylic ester and a co-polymerizable compound.

Specific examples of the co-polymerizable compounds include, but are not limited to, addition-polymerizable carboxylic acids, styrene, α-methyl styrene, vinyl toluene, 2,4-dimethyl styrene, ethyl styrene, isopropyl styrene, butyl styrene, phenyl styrene, cyclohexyl styrene, benzyl styrene, crotyl benzene, divinyl benzene, divinyl toluene, divinyl xylene, trivinyl benzene, vinyl naphthalene, ethylene, propylene, butene, isobutylene, pentene, heptene, diisobutylene, octane, dodecene, octadecene, butadiene, isoprene, 1,4-pentadiene, 1,6-hexadiene, and 1,7-octadien.

Polyester Unit

Known polyesters can be used as the polyester unit. The polyester unit is polymerized by, for example, condensation polymerization of a polyol and a polycarboxylic acid and ring-opening polymerization of lactones. In light of the latitude of designing resins, the condensation polymerization of a polyol and a polycarboxylic acid is preferred.

Polyol

As the polyols, it is possible to suitably use polyols having three or more hydroxyl groups in addition to the diols mentioned above.

Specific examples thereof include, but are not limited to, multi-valent aliphatic alcohols (such as glycerin, trimethylol ethane, trimethylol propane, pentaerythritol, sorbitol), tri- or higher valent phenols (such as trisphenol PA, Phenol novolac, cresol novolac) and adducts of the tri- or higher valent phenols mentioned above with alkylene oxides.

Polycarboxylic Acid

As the polycarboxylic acids, known dicarboxylic acids and known compounds having three or more carboxylic acids can be used.

Specific examples thereof include, but are not limited to, alkylene dicarboxylic acids (such as succinic acid, adipic acid, sebacic acid), alkenylene dicarboxylic acids (such as maleic acid and fumaric acid), aromatic dicarboxylic acids (such as futhalic acid, isophthalic acid, terephthalic acid, and naphthalene dicarboxylic acid) and polycarboxulic acids (such as trimelitic acid and pyromelitic acid) having 9 to 20 carbon atoms.

Method of Synthesizing Hybrid Resin

Known methods can be used as a method of synthesizing a hybrid resin having a polymer unit having a monool skeleton in its branched chain and a polyester unit. For example,
(1) perform polymerization of the polymer unit having a monool skeleton in its branched chain under the presence of a polyester having a addition-polymerizable functional group such as vinyl group, allyl group and (meth)acryloyl group;
(2) perform polymerization of the polyester unit under the presence of a polymer having a monool skeleton in its branched chain and a functional group such as hydroxyl group, carboxylic acid group and amino group having an active hydrogen; and
(3) perform addition polymerization and condensation polymerization simultaneously or sequentially under the presence of an addition-polymerizable carboxylic ester, a compound copolymerizable therewith, a polyol, a polycarboxylic acid and an addition-polymerizable compound having at least one functional group selected from the group consisting of carboxyl group, hydroxyl group, amino group and epoxy group.

Any known polyester based resins can be used as the polyester resins for use in the present invention. The polyester resins can be obtained by, for example, condensation polymerization of the polyol and the polycarboxylic acid mentioned above and ring-opening polymerization of lactones.

Further, in the present invention, in addition to the resin mentioned above having a polyester skeleton, other known resins such as polystyrene, acrylic resins, styrene-acryl ester copolymers, polyamides, petroleum based resins, and natural resins such as rosin for toner binder resins can be mixed in a desired amount within which the object of the present invention can be achieved. The content of these other known resins for toner binder resins in the present invention is not greater than 40% by weight, and preferably not greater than 30% by weight and more preferably not greater than 20% by weight.

Wax Other than Hydrocarbon Based Wax

Other known waxes can be contained in addition to the hydrocarbon based wax mentioned above if desired as long as the effect of the present invention is not significantly lost.

Colorant

One or more known colorants can be used for the toner of the present invention, in amounts conventionally used.

Master Batch of Colorant

The colorant for use in the present invention can be used in combination with the resin mentioned above as a master batch. The preparation of such a master batch is within the knowledge of one of ordinary skill in the art.

Post-Treatment Agent

As external additives to improve fluidity, developability and chargeability of the toner obtained in the present invention, inorganic particulates can be preferably used. Such an inorganic particulate preferably has a primary particle diameter of from 2 nm to 2 μm and particularly preferably of from 5 nm to 5 mμ. In addition, the specific surface area of such an inorganic particulate by BET method is preferably from 20 to 500 m²/g. The content of such an inorganic particulate is preferably from 0.01 to 5% by weight and particularly preferably from 0.01 to 2.0% by weight based on the content of the toner.

Specific examples of the inorganic particulates include, but are not limited to, silica, alumina, titanium oxide, barium titanate, magnesium titanate, calcium titanate, strontium titanate, zinc oxide, tin oxide, quartz sand, clay, mica, wollastonite, diatom earth, chromium oxide, cerium oxide, colcothar, antimony trioxide, magnesium oxide, zirconium oxide, barium sulfate, barium carbonate, calcium carbonate, silicon carbide, and silicon nitride.

Manufacturing Method

The toner of the present invention can be manufactured by any known method, preferably by manufacturing mother toner particles through a process of mixing a toner material, a process of fusing and kneading the mixture, a process of pulverizing the resultant, and a process of classifying the resultant and finally external additives are added to the mother toner particles.

In addition, powder not obtained as product particulates in the pulverizing process or the classifying process can be returned to the mixing process and the fusing and kneading process for reuse.

Mixing Process

In the process of mixing a toner material, at least a binder resin, a hydrocarbon based wax, the compound represented by the chemical structure (1), and a colorant can be mixed by a known mixer, such as a HENSCHEL MIXER, but the following method is preferred.

That is: instead of separately putting a binder resin and a hydrocarbon based wax in a mixer, the hydrocarbon based wax is dissolved or dispersed in a monomer which is a material for a binder resin in advance; the monomer is polymerized to synthesize a binder resin containing the hydrocarbon based wax; and at least the binder resin containing the hydrocarbon based wax, the compound represented by the chemical structure (1), and a colorant are mixed by a known mixer such as HENSCEL MIXER to obtain a toner material mixture. Thereby, it is possible to further uniformly disperse a hydrocarbon based wax on the surface of a toner or inside thereof. As a result, the toner can have stable developing characteristics.

Fusing and Kneading Process

Subsequent to the mixing process, the mixture obtained is placed and fused and kneaded in a kneading machine. As the kneading machine, a one roll or two roll continuous kneading machine and a batch kneading machine using a roll mill can be preferably used, such as for example, a KTK type two roll extruder manufactured by Kobe Steel Ltd., a TEM type extruder manufactured by Toshiba Machine Co., Ltd., a two roll extruder manufactured by Asada Iron Works Co., Ltd, a PCM type two roll extruder manufactured by Ikegami Ltd, and a Cokneader manufactured by Buss Co., Ltd. It is desired to perform this fusion and kneading in a suitable condition in which molecular chains of a binder resin are not severed. To be specific, the fusion and kneading are performed at a temperature with reference to the softening point of a binder resin. When the temperature is too low relative to the softening point, molecular chains are severely severed. When the temperature is too high, the dispersion is not sufficient.

Pulverization Process

After completing the fusing and kneading process, the kneaded matters obtained are pulverized. In the pulverizing process, the kneaded matters are preferably coarsely pulverized and then finely pulverized. Preferred methods of pulverizing particles of the kneaded matters are, for example, colliding the particles with a collision board in the jet air, colliding the particles with each other and pulverizing the particles at a small gap between a rotor mechanically rotating and a stator.

Classifying Process

After completion of the pulverizing process, the obtained pulverized matters are classified in the air by centrifugal force, etc., to obtain a developer having a desired particle diameter, for example, 4 to 10 μm.

The toner of the present invention preferably has at least one endothermic peak in the range of from 60 to 80° C. with a half value width of not greater than 8° C. when measured by a differential scanning calorimetry (DSC).

The endothermic peak is based on the melting point of the hydrocarbon based wax used in the present invention. When the endothermic peak is too high, for example higher than 80° C., the effect of the present invention is not sufficiently obtained. The considerable reason therefor is that the wax is hard and does not have an effect of protecting the surface of the toner. When the endothermic peak is too low, for example lower than 60° C., the fluidity of the toner deteriorates and a thin layer of the toner on a toner supplying member is non-uniform, resulting in significant deterioration of image quality, which is not preferred.

In addition, the half value width of the endothermic peak that is too wide, for example 8° C. is not preferred because the fluidity of the toner deteriorates. It is preferred that the half value width is narrow and more preferably not greater than 6° C.

Analysis Method

Method of Measuring by Differential Scanning Calorimetry (DSC)

The calorimeter used is DSC6200 manufactured by Seiko Instruments Inc.

A sample, 5 mg of a wax or a toner containing the wax measured using an aluminum pan, is placed in a DSC device. The sample is heated from room temperature to 200° C., cooled down to 0° C. with a rate of −10° C./minute and measured at a rate of +10° C./min while heated again.

The results are plotted with reference to temperature and heat flow and the temperature (i.e., endothermic peak) at which the heat flow is the minimum is determined as the melting point of the wax.

In addition, a line segment is drawn vertically from the endothermic peak to the base line. The temperature difference between the two intersections of the temperature and heat flow plot and the line passing through the center of the line segment and in parallel with the base line is determined as the half value width of the endothermic peak

Measuring Acid Value

The acid value is measured as follows: Precisely weigh 1 to 1.5 g of a wax in a conical flask; Add 20 ml of xylene thereto; subsequent to heating and melting, add 20 ml of dioxane thereto; and quickly titrate the liquid resultant with N/10 potassium hydroxide normal methanol solution using 1% phenolphthalein solution as an indicator before the liquid resultant is clouded. A blank test is performed simultaneously.

Calculation Expression:
Acid value=[5.61×(A−B)×f]/S.
In the calculation expression,
A represents the content (ml) of N/10 potassium hydroxide normal methanol solution used in the test;
B represents the content (ml) of N/10 potassium hydroxide normal methanol solution used in the blank test;
f represents a factor of N/10 potassium hydroxide normal methanol solution; and
S represents the weight of a sample (g).
Analysis of Ratio of Monool Skeleton to Diol Skeleton

The contents of the diol skeleton and the monool skeleton are measured by reaction pyrolysis gas chromatography.

Device and Reagent

Pretreatment: JHP-3S (manufactured by Japan Analytical Industry Co., Ltd.)

Analysis: QP-5000 (manufactured by Shimadzu Corporation)

Derivatizing reagent: tetramethyl ammonium hydroxide (TMAH).

Analysis Conditions

Thermal decomposition temperature: 360° C., 12 seconds

Ion source: EI 70 eV

Weight range: m/z 40-650

Column: Ultra Alloy-5 L=30 m, I.D=0.25 m Film=0.25 μm

Column temperature: 40° C. (5 minutes) to 320° C. at a rising rate of 10° C./minute

Vaporization chamber temperature: 280° C.

Carrier gas: He

Measuring the contents of the diol skeleton and the monool skeleton is performed as follows: Dilute a toner sample to a concentration of 1 to 10% with dimethyl formaldehyde (DMF); Drop 1 μl of the obtained toner liquid to a pyrofoil; Evaporate dimethyl formaldehyde to dry and solidify the toner sample; Drop 2 μl of 25% aqueous tetramethyl ammonium solution thereto; and thermally decompose the resultant at the pyrofoil for measurement.

When the total area of the dimethylated compound measured by Total Ion Chromatography (TIC) is D and the total area of the monomethylated compound is M, D/M is determined as the weight ratio of the diol skeleton to the monool skeleton in the resin.

Toner Particle Diameter

The particle diameter of the toner particle is measured by Coulter Counter method.

As a measuring device for measuring the particle size distribution of toner particles by Coulter Counter method, Coulter Counter TA-II, Coulter Multisizer II and Coulter Multisizer III (all of which are manufactured by Beckman Coulter Inc.) can be used. The measuring method is as follows: Add 0.1 to 5 ml of a surface active agent (preferably alkyl benzene sulfonate salt) as a dispersant in 100 to 150 ml of an electrolytic solution (for example, ISOTOON-II, manufactured by Beckman Coulter Inc.), which is about 1% NaCl aqueous solution prepared by using primary sodium chloride; Add 2 to 20 mg of a solid sample; Perform dispersion for the electrolytic solution in which the sample is suspended in a supersonic dispersion device for about 1 to about 3 minutes; and measure the volume or the number of the toner (particles) using the measuring device mentioned above with an aperture of 100 μm to calculate the volume distribution and the number distribution. The weight average particle diameter (Dv) and the number average particle diameter (Dn) can be obtained from the obtained distributions.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is described in detail with reference to specific Examples but is not limited thereto.

Manufacturing of Resin 1

Resin 1 is manufactured as follows.

Place the following components in a dropping funnel.

| | | |
|---|---|---|
| styrene as a styrene based monomer | 590 | g |
| 2-ethylhexyl acrylate as an acryl based monomer | 120 | g |
| acrylic acid as an acryl based monomer | 30 | g |
| dicumyl peroxide as a polymerization initiator | 30 | g |

Place the following components in a 5 liter flask equipped with a thermometer, a stainless steel stirrer, a flow-down condenser and a nitrogen introducing tube.

| | | |
|---|---|---|
| polyoxypropylene (2,2)-2,2-bis(4-hydroxyphenyl) propane | 1,260 | g |
| polyoxyethylene (2,2)-2,2-bis(4-hydroxyphenyl) propane | 130 | g |
| isododecenyl succinic anhydride | 200 | g |
| terephthahlic acid | 380 | g |
| 1,2,4-benzene tricarboxylic anhydride | 270 | g |
| dibutyl tin oxide as an esterization catalyst | 7 | g |
| W1 (paraffin wax, acid value: less than 0.1 mgKOH/g; | 250 | g |
| melting point: 73.3° C.; half value width of endothermic peak | | |
| measured at temperature rising by a differential scanning | | |
| calorimeter (DSC)) as wax | | |

Drop the mixture of a vinyl based monomer resin and the polymerization initiator by the dropping funnel to the flask over one hour while stirring the components in the flask at 160° C. in the nitrogen atmosphere in a mantle heater. After the addition polymerization reaction for 2 hours at 160° C., the resultant is heated to 230° C. for condensation polymerization. The degree of the polymerization is traced by the softening point measured by a constant load extruder narrow tube type rheometer and the reaction is ended at a desired softening point to obtain Resin 1.

Resins 2, 6 and 7 are manufactured in the same manner as in Example 1 using the material components shown in Table 1.

Manufacturing of Resin 3

Resin 3 is manufactured as follows:

Place the following components in a 5 liter flask equipped with a thermometer, a stainless steel stirrer, a flow-down condenser and a nitrogen introducing tube.

| | | |
|---|---|---|
| polyoxypropylene (2,2)-2,2-bis(4-hydroxyphenyl) propane | 1,650 | g |
| polyoxyethylene (2,2)-2,2-bis(4-hydroxyphenyl) propane | 660 | g |
| isododecenyl succinic anhydride | 190 | g |
| terephthahlic acid | 750 | g |
| 1,2,4-benzene tricarboxylic anhydride | 190 | g |
| dibutyl tin oxide as an esterization catalyst | 0.3 | g |

Heat the components in the flask to 230° C. in a nitrogen atmosphere in a mantle heater to advance a condensation polymerization reaction. The polymerization degree is traced by the softening point measured by a constant load extruder narrow tube type rheometer and the reaction is ended at a desired softening point to obtain Resin 3.

Resins 4 and 5 are manufactured in the same manner as in Example 3 using the material components shown in Table 1.

### Example 1

The following components are sufficiently mixed with a blender and then kneaded with a two-roll extruder.

| | | |
|---|---|---|
| Resin 1 | 74 | parts |
| Resin 3 | 26 | parts |
| Charge controlling agent (Compound | 2.5 | parts |
| represented by Chemical structure (1) | | |
| Colorant (PigmentBlue 15:3) | 4 | parts |

Subsequent to cooling down, the resultant is pulverized and classified to obtain a cyan color mother toner having a volume average particle diameter of 7.9 μm.

100 parts of the mother toner and 0.4 parts of hydrophobic silica (surface treated with hexamethyl disilazane, the average particle diameter of the primary particle thereof: 0.02 μm) are mixed with a HENSCHEL MIXER to obtain a cyan color toner.

The endothermic curve of this toner (Toner 1) is measured by DSC6200 (manufactured by Seiko Instruments Inc.) based on differential scanning calorimetry according to the temperature rise and fall mentioned above. The DSC chart, and the endothermic peak and the half value width based thereon are shown in FIG. 2. In addition, the following endurance test in a developing device is performed for the toner: Place the toner in the developing unit in IPSIO CS2500 (manufactured by Ricoh Co., Ltd.); Leave the toner therein a high heat and high humidity (H/H) environment (27° C. and 80%) for 24 hours; Put the developing unit at the position of the black color developing unit of IPSIO CS2500 under the H/H environment; Output 4,000 white solid images; and output the Test chart No. 1R according to The Imaging Society of Japan for evaluation with the following criteria.

E: No problem

G: Noises (such as background fouling and streaks) are slightly observed but not a practical problem

F: Noises (such as background fouling and streaks) are clearly observed and makes a practical problem

B: Noises (such as background fouling and streaks) are significantly observed and makes a practical problem

E and G are evaluated as acceptable. The evaluation results are shown in Table 2.

### Examples 2 to 8

Toners 2 to 8 are manufactured and evaluated in the same manner as in Example 1 using the resin and wax components shown in Table 2.

### Comparative Examples 1 to 4

Toners 101 to 104 are manufactured and evaluated in the same manner as in Example 1 using the resin and wax components shown in Table 2.

The waxes used are shown in Table 3. The charge controlling agents used are shown in Table 4.

The evaluation results for Examples 1 to 8 and Comparative Examples 1 to 4 are shown in Table 2.

TABLE 1

| | Styrene based monomer and | | | | | Polyester monomer | | | | | | | |
|---|---|---|---|---|---|---|---|---|---|---|---|---|---|
| | acryl based monomer | | | | Initiator | | BPA- | | | | Catalyst | | |
| | St | BA | 2EHA | AA | DCPO | BPA-PO | EO | i-DSA | TPA | TMA | DBTO | Wax | |
| | (g) | (g) | (g) | (g) | (g) | (g) | (g) | (g) | (g) | (g) | (g) | Kind | (g) |
| R 1 | 590 | — | 120 | 30 | 30 | 1,260 | 130 | 200 | 380 | 270 | 7 | W1 | 210 |
| R 2 | 600 | 110 | — | 30 | 30 | 1,230 | 290 | 250 | 310 | 180 | 7 | W1 | 460 |
| R 3 | — | — | — | — | — | 1,650 | 660 | 190 | 780 | 190 | 0.3 | — | — |
| R 4 | — | — | — | — | — | 2,390 | — | — | 920 | 120 | 0.3 | — | — |
| R 5 | — | — | — | — | — | 1,650 | 660 | 190 | 750 | 190 | 0.3 | — | — |
| R 6 | 590 | — | 120 | 30 | 30 | 1,260 | 130 | 200 | 380 | 270 | 7 | — | — |
| R 7 | 590 | — | 120 | 30 | 30 | 1,260 | 130 | 200 | 380 | 270 | 7 | W3 | 210 |

R1 to R5 represent Resin 1 to Resin 5.
St represents styrene.
BA represents butyl acrylate.
2EHA represents 2-ethylhexyl acrylate.
DCPO represents dicumyl peroxide.
BPA-PO represents polyoxypropylene (2,2)-2,2-bis(4-hydroxyphenyl) propane.
BPA-EO represents polyoxyethylene (2,2)-2,2-bis(4-hydroxyphenyl) propane.
i-DSA represents isododecenyl succinic anhydride.
TPA represents terephthahlic acid.
TMA represents 1,2,4-benzene tricarboxylic anhydride.

DBTO represents dibutyl tin oxide.

TABLE 2

| | | | | | | Charge | | | | | | | |
|---|---|---|---|---|---|---|---|---|---|---|---|---|---|
| | | | | | | controlling | | | | DSC | | Diol/ | |
| | | Resin 1 | | Resin 2 | | agent | | Wax | | Peak | Half | monool | |
| | | Kind | Parts | Kind | Parts | Kind | Parts | Kind | Parts | (° C.) | (° C.) | ratio | Eva |
| EX 1 | T 1 | R 1 | 74 | R 3 | 26 | C1 | 2.5 | — | | 73.1 | 3.9 | 96/4 | E |
| EX 2 | T 2 | R 1 | 74 | R 3 | 26 | C1 | 3.2 | — | | 73.3 | 4.0 | 95/5 | E |
| EX 3 | T 3 | R 1 | 74 | R 3 | 26 | C1 | 1.5 | — | | 73.2 | 4.0 | 96/4 | E |
| EX 4 | T 4 | R 2 | 40 | R 4 | 60 | C1 | 2.5 | — | | 73.2 | 3.8 | 99/1 | G |
| EX 5 | T 5 | R 5 | 57 | R 3 | 40 | C1 | 2.5 | W1 | 3 | 73.2 | 3.8 | 100/0 | G |
| EX 6 | T 6 | R 7 | 74 | R 3 | 26 | C1 | 2.5 | — | | 79.2 | 9.5 | 96/4 | G |
| EX 7 | T 7 | R 1 | 74 | R 3 | 26 | C3 | 2.5 | — | | 73.0 | 3.8 | 96/4 | E |
| EX 8 | T 8 | R 1 | 74 | R 3 | 26 | C4 | 2.5 | — | | 73.3 | 3.9 | 96/4 | G |
| CEX 1 | T 101 | R 6 | 73 | R 3 | 27 | C1 | 2.5 | — | | 73.4 | 4.1 | 96/4 | B |
| CEX 2 | T 102 | R 6 | 70 | R 3 | 25 | C1 | 2.5 | W2 | 5 | 72.5 | 6.8 | 97/3 | F |
| CEX 3 | T 103 | R 1 | 74 | R 3 | 26 | C2 | 2.5 | — | | 73.1 | 3.9 | 96/4 | B |
| CEX 4 | T 104 | R 1 | 74 | R 3 | 26 | — | — | — | | 73.2 | 3.9 | 96/4 | B |

Exs 1 to 8 represent Examples 1 to 8.
CEX 1 to 4 represent Comparative Examples 1 to 4.
Rs 1 to 7 represent Resins 1 to 7.
Peak represents endothermic peak.
Half represents half width value.

Eva represents evaluation.

TABLE 3

| | | Melting | Half value | Acid value |
|---|---|---|---|---|
| Wax | Kind | point (° C.) | width (° C.) | (mgKOH/g) |
| W1 | Paraffin wax (A) | 73.0 | 3.9 | <0.1 |
| W2 | Carnauba wax | 83.1 | 5.2 | 2.3 |
| W3 | Paraffin wax (B) | 79.3 | 9.2 | <0.1 |

TABLE 4
The CCAs (charge controlling agents)
used in Table 2 are shown in Table 4.

| CCA | kind |
|---|---|
| C1 | 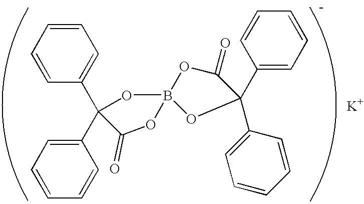 |
| C2 | 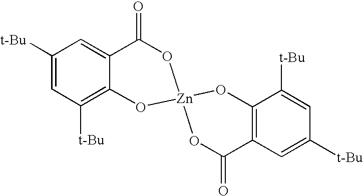 |
| C3 | 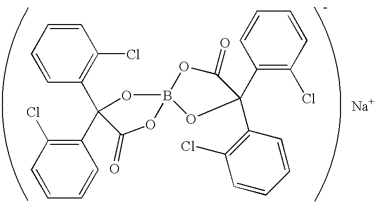 |
| C4 | 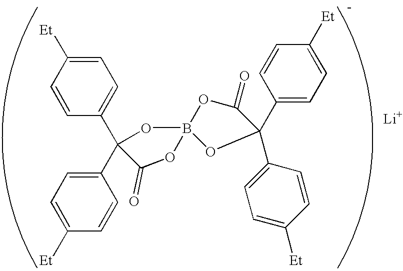 |

This document claims priority and contains subject matter related to Japanese Patent Application No. 2005-223154 filed on Aug. 1, 2006, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a binder resin comprising a resin having a polyester skeleton;
a wax comprising a hydrocarbon based wax;
a colorant;
a charge controlling agent represented by the following chemical structure;
wherein the toner has at least one endothermic peak in a range of from 60 to 80° C. when measured by differential scanning calorimetry (DSC): 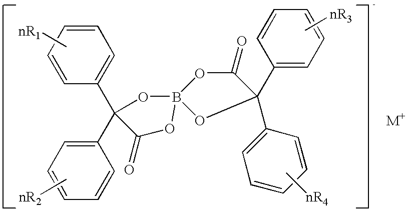
wherein M represents one of Li, Na and K, R₁, R₂, R₃ and R₄ each, independently, represent one of a hydrogen atom, an alkyl group having 1 to 4 carbon atoms, an alkoxy group having 1 to 4 carbon atoms, or a halogen atom, and n represents an integer of from 1 to 5, and when n is from 2 to 5, each of R₁, R₂, R₃ and R₄ can be different from the other.

2. The toner according to claim 1, wherein the binder resin comprises a polyester based resin.

3. The toner according to claim 1, wherein the binder resin comprises a hybrid resin having a styrene skeleton portion and a polyester skeleton portion.

4. The toner according to claim 1, wherein a half width value of the endothermic peak is not greater than 8° C.

5. The toner according to claim 1, wherein the polyester skeleton of the binder resin comprises diol skeleton units and monool skeleton units, wherein a ratio of a weight of the diol skeleton units to a weight of the monool skeleton units in the binder resin is from 99/1 to 75/25.

6. The toner according to claim 1, wherein the hydrocarbon based wax has an acid value of not greater than 0.5 mgKOH/g.

7. The toner according to claim 1, wherein a content of the hydrocarbon based wax is from 2 to 15 parts by weight based on 100 parts by weight of the binder resin.

8. The toner according to claim 1, wherein a content of the charge controlling agent is from 0.5 to 5 parts by weight based on 100 parts by weight of the binder resin.

9. A developing device, comprising:
a toner transfer member;
a toner supplying member configured to supply the toner of claim 1 to a surface of the toner transfer member; and
a toner regulating member configured to regulate a layer thickness of the toner supplied to the surface of the toner transfer member while contacting the toner transfer member.

10. The developing device according to claim 9, wherein the toner supplying member has a roller form.

11. An image forming method comprising:
charging an image bearing member;
irradiating a surface of the image bearing member to form a latent electrostatic image thereon;
supplying the toner of claim 1 by a toner supplying device to a surface of a toner transferring member;
regulating a thickness of a layer of the toner on the surface of the toner transferring member,
developing the latent electrostatic image with the toner to form a visualized toner image;
transferring the visualized toner image to a recording medium; and
cleaning the surface of the image bearing member.

12. The image forming method according to claim 11, wherein the toner supplying device has a roller form.

13. The image forming method according to claim 11, wherein the polyester resin comprises a polyester based resin.

14. The image forming method according to claim 11, wherein the binder resin of the toner comprises a hybrid resin having a styrene skeleton portion and a polyester skeleton portion.

15. The image forming method according to claim 11, wherein a half width value of the endothermic peak is not greater than 8° C.

16. The image forming method according to claim 11, wherein the polyester skeleton of the binder resin comprises diol skeleton units and monool skeleton units, and wherein a ratio of a weight of the diol skeleton units to a weight of the monool skeleton units in the binder resin is from 99/1 to 75/25.

17. The image forming method according to claim 11, wherein the wax has an acid value of not greater than 0.5 mgKOH/g.

18. The image forming method according to claim 11, wherein a content of the hydrocarbon based wax is from 2 to 15 parts by weight based on 100 parts by weight of the binder resin.

19. The image forming method according to claim 11, wherein a content of the charge controlling agent is from 0.5 to 5 parts by weight based on 100 parts by weight of the binder resin.

20. A process cartridge comprising:
a toner transfer member;
a toner supplying member configured to supply the toner of claim 1 to a surface of the toner transfer member; and
a toner regulating member configured to regulate a layer thickness of the toner supplied to the surface of the toner transfer member while contacting the toner transfer member.
